(19) United States
(12) Patent Application Publication
(10) Pub. No.: US 2022/0129962 A1
(43) Pub. Date: Apr. 28, 2022

(54) SERVICE DISPATCHING SYSTEM AND METHOD

(71) Applicant: Salubrite NET 2 GO inc., Laval (CA)

(72) Inventor: Razmig Boussouyan, Montreal (CA)

(21) Appl. No.: 17/452,627

(22) Filed: Oct. 28, 2021

Related U.S. Application Data
(60) Provisional application No. 63/106,461, filed on Oct. 28, 2020.

(51) Int. Cl. G06Q 30/06; G06Q 50/10; H04W 4/02

(52) U.S. Cl. CPC G06Q 30/0611; G06Q 30/0641; H04W 4/025; G06Q 50/10; G06Q 30/0617

(57) ABSTRACT

A service dispatching system and method configured to match customers and service providers. The service dispatching system comprises a server in communication with customer systems and provider systems. Upon receiving a service request from a customer system, the server dispatches the service request to a number of provider systems meeting the requirements established by the customer system. If a provider system accepts the service request, the server may further dispatch the service request to a sub-user of the provider system.

### CROSS-REFERENCE TO RELATED APPLICATIONS

The present patent application claims the benefit of priority of U.S. Provisional Patent Application No. 63/106,461 filed on Oct. 28, 2020 at the United States Patent and Trademark Office and entitled “Service Dispatching System and Method”, the content of which is incorporated herein by reference.

### FIELD OF THE INVENTION

The present invention generally relates to the field of data communications in general and more particularly, to service dispatching systems.

### BACKGROUND OF THE INVENTION

Despite an increased access to information, customers seeking a service are often overwhelmed with the number of available options. The large amount of information offered by service providers as part of their marketing may overwhelm certain customers who seek to inform themselves and ensure that the services meet their needs. Contrarily, certain providers do not provide enough information thereby forcing customers to contact them in order to inform themselves.

This customer information acquisition phase is time-consuming and can be demanding for certain customers. This is particularly problematic when a customer is hoping to quickly obtain a service. There is therefore a need for a service dispatching system capable of assessing the needs and of a customer and thereafter assigning that customer's request to a service provider located near the customer and capable of providing the service.

### SUMMARY OF THE INVENTION

The aforesaid and other objectives of the present invention are realized by generally providing a service dispatching system comprising a server, a customer system in communication with the server operable to send a service request, and one or more provider systems in communication with the server operable to receive the service request, wherein the provider system is further configured to dispatch the service request to a sub-user of the provider system. The server may additionally be configured to selectively restrict communication between the customer system and the provider system.

The present invention is further directed to a method of dispatching a service comprising receiving a service request from a customer device, dispatching the service to one or more service providers, receiving an acceptance notification from one of the one or more service providers, scheduling an appointment, and dispatching the appointment to a sub-user of the service provider. The method may further comprise preparing an automated estimated cost and prompting the customer device to accept the estimated cost.

The features of the present invention which are believed to be novel are set forth with particularity in the appended claims.

### BRIEF DESCRIPTION OF THE DRAWINGS

The above and other objects, features and advantages of the invention will become more readily apparent from the following description, reference being made to the accompanying drawings in which:

FIG. 1 discloses an overview of the elements involved with the present invention.

FIG. 2 is an example of a provider interface in accordance with the present invention.

FIG. 3 is an example of a customer interface in accordance with the present invention.

FIG. 4 is another example of the customer interface illustrated in FIG. 3.

FIG. 5 is yet another example of the customer interface illustrated in FIG. 3.

FIG. 6 is an example of a scheduling interface in accordance with the present invention.

FIG. 7 is another example of the scheduling interface illustrated in FIG. 6.

FIG. 8 is an example of a confirmation interface in accordance with the present invention.

FIG. 9 is a block diagram of a service dispatching method in accordance with the present invention.

FIG. 10 is a block diagram of a first step of the service dispatching method of FIG. 9.

FIG. 11 is a block diagram of a second step of the service dispatching method of FIG. 9.

FIG. 12 is a block diagram of a third step of the service dispatching method of FIG. 9.

FIG. 13 is a block diagram of a fourth step of the service dispatching method of FIG. 9.

FIG. 14 is a block diagram of a fifth step of the service dispatching method of FIG. 9.

### DETAILED DESCRIPTION OF THE PREFERRED EMBODIMENT

A novel service dispatching system and method will be described hereinafter. Although the invention is described in terms of specific illustrative embodiment(s), it is to be understood that the embodiment(s) described herein are by way of example only and that the scope of the invention is not intended to be limited thereby.

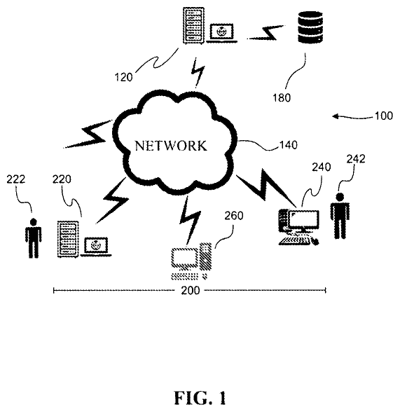

Referring to FIG. 1, the service dispatching system 100 comprises an essential service dispatching server 120 coupled to a network 140. By means of the network 140, the service dispatching server 120 may be connected to a plurality of computer systems 200 operated by various forms of users of the service dispatching system 100. In particular embodiments of the present invention, the various users of the service dispatching system 100 may comprise service providers 222, customers 242 and administrators (not shown). To that end, the computer systems 200 may comprise one or more provider systems 220, one or more customer systems 240, and one or more administrator systems 260.

The service dispatching server 120, being an essential element of the present invention, comprises a piece of computer hardware providing functionality to the remaining elements of the invention, namely the provider systems 220, one or more customer systems 240, and one or more administrator systems 260. The service dispatching server 120 comprises a processor having a performance at least equivalent to a 1.06 GHz Intel Core 2 processor, at least 1 GB of random access memory (RAM) and a storage device of at least 1 GB.

The computer systems 200 are known to include processors running operating systems, storage mediums, input devices and an output, the interfaces of which are described in further detail below. In certain embodiments, the computer systems 200 may comprise a desktop computer, a laptop, a mobile phone, a tablet, a smartwatch, or any other suitable device for storing and processing data. The computer systems 200 may utilize a web browser, an application, or any other suitable program to enable the communication with other components of the service dispatching system 100. The service dispatching system 100, in accordance with the embodiment illustrated in FIG. 1, allows for data information to be integrated from all computer systems 200. The computer systems 200 may further communicate with the service dispatching server 120 via the world wide web. Files transferred by means of the service dispatching system 100 can be in different text, graphic, audio and video format using any well-known page description language.

In certain embodiments, the service dispatching system 100 may be configured to match a customer 242 seeking a service in a certain geographical area with a service provider 222 meeting their requirements and available to offer said services. The service dispatching system 100 may allow the customers 242 to access various forms of services including, but not limited to, housekeeping services, convenience services, professional services, financial services. Accordingly, the customers 242 may be able to book appointments for services using the customer system 240.

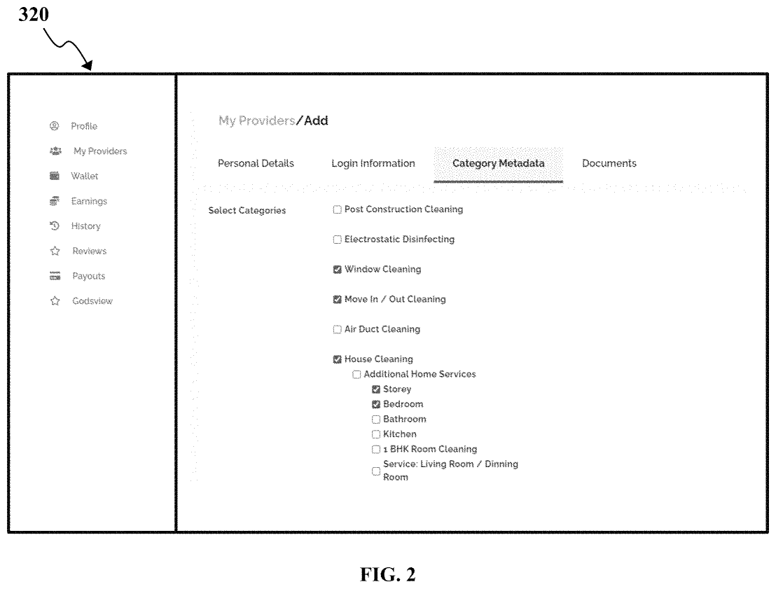

The services offered by a particular service provider 222 may be defined by the service provider 222 using the provider system 220 by means of a provider interface 320, an example embodiment of which is shown in FIG. 2. In certain embodiments, the provider interface 320 may additionally allow the service provider 222 to modify their services (i.e. the nature of the services, pricing, geographic reach, etc.), view and modify past and upcoming appointments, view financial information (i.e. business performance, etc.), review past activities, and to create additional sub-users of the provider system 220 as further detailed below.

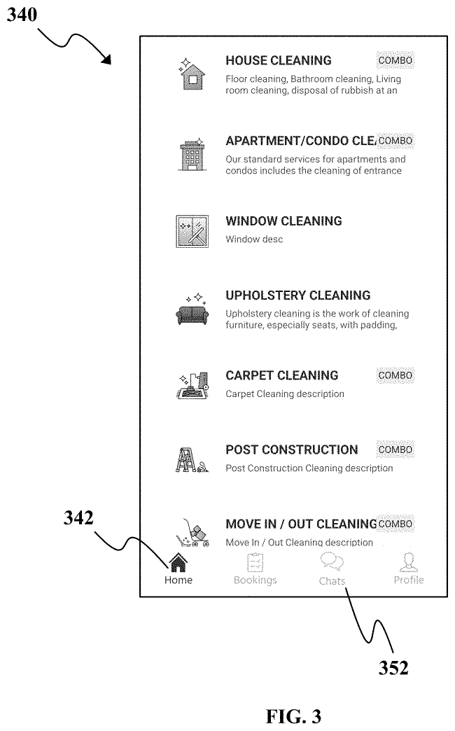

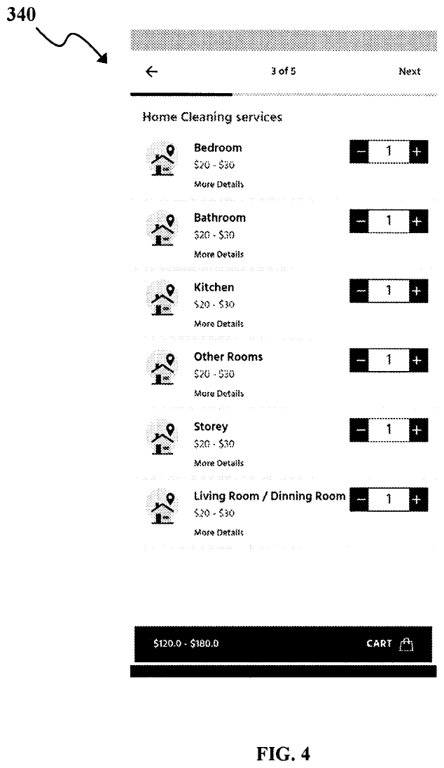

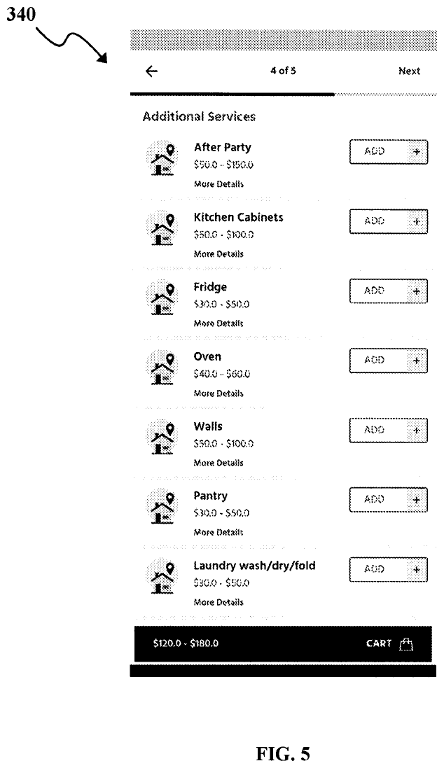

Referring now to FIG. 3, an example embodiment of a customer interface 340 is shown allowing a customer 242 to search for available services in their area, book and modify appointments and communicate with a service provider 222. Accordingly, the customer interface 340 may allow the customer 242 to search for services available in their area and within the time frame desired by the customer within a first tab 342. Alternatively, the customer interface 340 may present the customer 242 a list of services available in their area based on a customer profile generated by the customer 242 within said first tab 342. In certain embodiments and as shown in FIGS. 4 and 5, the service dispatching system 100 may additionally prompt the customer 242 for additional information regarding potential requirements of the customer 242. For example, a customer 242 seeking housekeeping services may be prompted to specify the number of rooms or bathrooms to be cleaned, whether they will additionally be requiring carpet cleaning services or pool cleaning services, whether they wish to have appliances cleaned or whether the cleaning is being performed after a particular event thereby requiring additional cleaning.

In certain embodiments, the service dispatching system 100 may further instruct the customer 242 regarding the additional information to be inputted in order to ensure the accuracy of said information. For example, the service dispatching system 100 may provide the customer 242 instructions as to how to measure the relevant surface area of a window to be cleaned, the number of window panes to be cleaned (as opposed to the number of window frames), the number of air returns present in the space to be cleaned or any other relevant information which may impact the cost of the services provided.

The information inputted into the customer interface 340 by the customer 242 may thereafter be used by the service dispatching system 100 to match the customer 242 to a service provider 222 having the appropriate equipment or staff to perform the requested services during the desired timeframe.

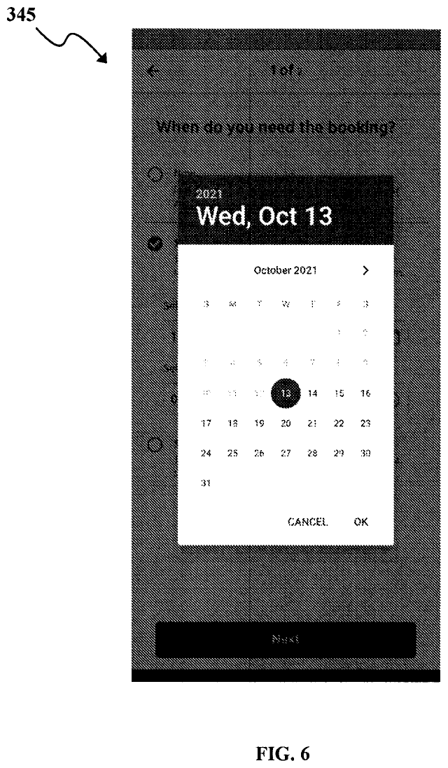

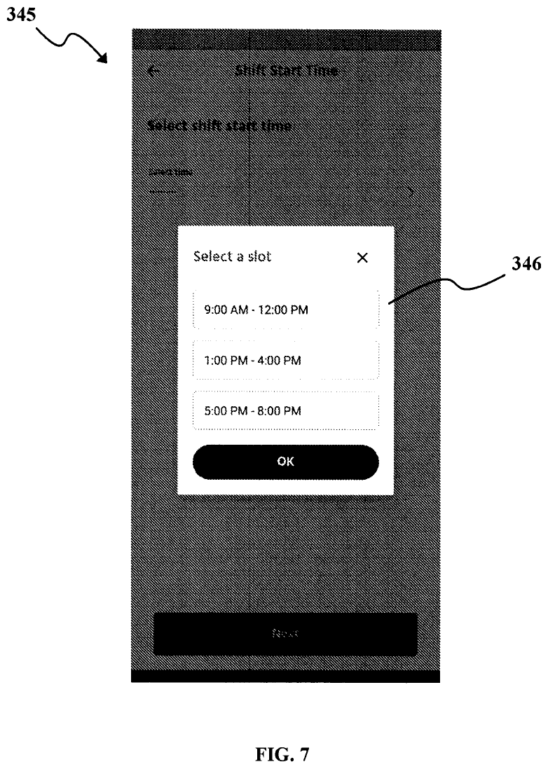

Referring now to FIGS. 6 and 7, the service dispatching system 100 may comprise a scheduling interface 345 adapted to allow the customer 242 to specify a date and time at which they would prefer to receive the services selected within the first tab 342. In certain embodiments, the scheduling interface 345 may provide time windows 346 during which the services may be provided.

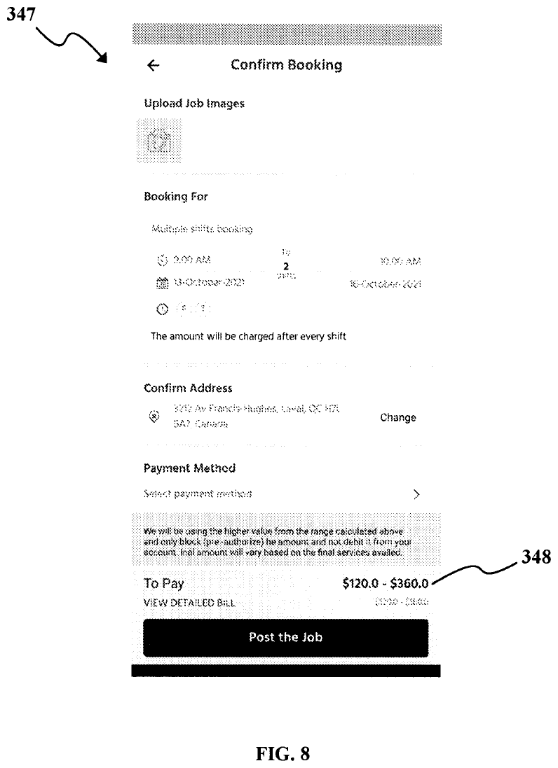

Referring now to FIG. 8, the service dispatching system 100 may additionally be configured to prompt the customer 242 with a confirmation interface 347 prior to the service being booked. The confirmation interface 347 may optionally comprise a price estimate 348 optionally presented in the form of a price range. The price estimate 348 may be automatically determined by the service dispatching system 100 in accordance with one or more factors including, but not limited to, the type of service requested, a number or bundle of services requested, the demand and supply for said services, the fees determined by the service provider 222, the estimated time required to perform the services selected within the first tab 342, the requirements of the customer 242, or any other relevant factors. For example, the price estimate 348 for housekeeping services may be provided based on the size of the property for which the service is requested, the elements of the property to requiring cleaning, the availabilities of housekeeping service providers in the geographic area of a customer 242 during the time windows 346 and other requirements of the customer 242 such as the number of rooms requiring cleaning or the square footage of their carpets as identified by the customer interface 340. In certain embodiments, a different price estimate 348 may be indicated for a clearly defined service or a service covering multiple variations. Moreover, the actual cost of the service may be adjusted after the performance of the service based on certain factors including, for example, unforeseen complications or the duration of the service.

Once the price estimate 348 has been determined, the confirmation interface 347 may display a confirmation box 349 allowing the customer 242 to consent to the price estimate 348 or the customer device 240 may be prompted to accept said price estimate 348. If the customer 242 accepts the estimated price estimate 348, the service request is thereafter dispatched to the provider systems 220 meeting the requirements established by the customer 242. In certain embodiments, the service request may be sent simultaneously to all provider systems 220 meeting the requirements. In other embodiments however, the service request may be first sent to one or more provider systems 220 having previously serviced the customer 242 and for which the customer 242 indicated a high level of satisfaction with the service (either by means of a reviewing system or any other suitable manner). In other embodiments still, the service request may be dispatched a first pool of provider systems 220 having a review rating surpassing a predetermined threshold rating and subsequently dispatching the service request to a second pool of provider systems 220 having a lower review rating if no service provider system 220 from the first pool accepts the service request within a predetermined period of time.

In the event that a service provider 222 cancels an appointment after having been booked, the service dispatching system 100 may be configured to resend the service request to other service providers 220 meeting the requirements. In certain embodiments, a service provider 222 having canceled multiple appointment may selectively receive fewer service requests.

Alternatively, a service provider 222 having promptly accepted multiple service requests may selectively receive a higher number of future service requests. The service dispatching system 100 may further consider additional factors such as, for example, reviews left by the customers 242 having previously serviced by the service provider 222.

In certain embodiments, the service dispatching system 100 may selectively withhold information from the customer 242 for a period of time prior to the appointment, for example the identity of the service provider 222. To that end, the service dispatching system 100 may limit or deny communication between the customer 242 and the service provider 222 for a period of time. In such embodiments, certain features of the customer interface 340 may be time-activated. For example and referring again to FIG. 3, a communication portal 352 of the customer interface 340 allowing the customer 242 to communicate with the service provider 222 may only become available in the 30 minutes leading up to a booked appointment. Other features of the customer interface 340 may be time-activated without departing from the scope of the present invention.

The service dispatching system 100 may additionally comprise a transaction module 180 configured to accept payments from the customers 242 and to transfer a portion or the entirety of the funds to the service providers 222. The transaction module 180 may be configured to hold a percentage or the entirety of the payment for the performance of a service once the appointment has been booked by the customer 242. The percentage or entirety of the payment may be held by the transaction module 180 for a predetermined period of time to allow a potential refund in the event of a conflict or problem. Similarly, the transaction module 180 may be adapted to only return a portion of the withheld funds if the customer 242 elects to cancel the booked appointment within a predetermined period prior to the scheduled booking time and/or if the customer 242 elects to cancel the booked appointment after the service provider 222 has arrived at the location associated with the service request. The transaction module 180 may further offer the customer 242 the option to include a gratuity after the service has been performed.

In a preferred embodiment, the provider interface 320 allows varying levels of access to its users. It may be appreciated that a service provider 222 may comprise multiple employees (or sub-users) holding varying different positions and having varying responsibilities. Accordingly, the provider interface 320 may be configured to provide a tailored experience for the different positions or functions held by employees of a service provider 222. In an example embodiment, the service dispatching system 100 may comprise an operator interface 322, a supervisor interface 324 and a leader interface 326. To that end, each interface would be accessible by the provider system 220 of a user and suited to be relevant to their respective responsibilities.

In certain embodiments, the operator interface 322 may grant its user, typically being a business owner, general administrative options associated to that service provider 222 (i.e. assigning access to other users, defining roles, etc.), a view of financials, a dispute resolution module, as well as access to any other relevant data. The supervisor interface 324, typically being accessible by an employee of the service provider 222 having a supervisor role, may be able to access scheduled appointments and assign employees to the appointments. Finally, the leader interface 326 may be accessible by an employee of the service provider 222 being assigned to an appointment and tasked with managing the specific appointment. The leader interface 326 may therefore allow its user to communicate with the customer 242, to confirm the details of the appointment as well as the nature of the services requested. In certain embodiments, the leader interface 326 may further allow its user to confirm the pricing generated by the service dispatching system 100 prior to performance of the service. Accordingly, the leader interface 326 may prompt its user to evaluate and confirm the services selected by the customer and the price estimate 348 generated by the service dispatching system 100. For example, a service request for housekeeping services may comprise a price estimate 348 requiring an amendment depending on the severity of the cleaning required by the customer 242. In case of a discrepancy, the leader interface 326 may allow its user to modify the price estimate 348. If the price estimate 348 is amended, the customer interface 340 may prompt the customer device 240 to accept the amended price estimate 348.

In certain embodiments, the provider system 220 may comprise an image capturing module (such as a camera) thereby allowing a user to capture photographs by means of the leader interface 326. The one or more captured photographs may be used to confirm the performance of the service for record keeping purposes or in the event that the customer 242 is not present at the location at the time at which the service is performed. Similarly, the provider system 220 may comprise a geo-localization module thereby allowing the service dispatching server 120 to record the arrival and departure times of the service provider 222. These times may allow the service dispatching server 120 to subsequently adjust the final cost of the service.

In certain embodiments, the administrative systems 260 of the service dispatching system 100 are configured to allow administrators to access and operate the service dispatching server 120. In so doing, the administrators may verify compliance by the service providers 222 and the customers 242, resolve disputes between service providers 222 and the customers 242, ensure the appropriate transfer of funds and all other tasks necessary for the operation of the service dispatching system 100.

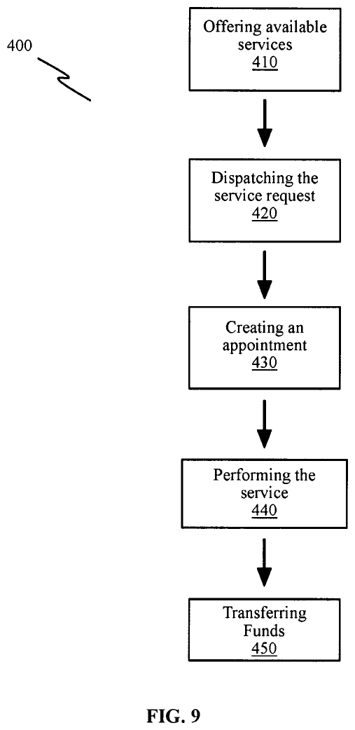

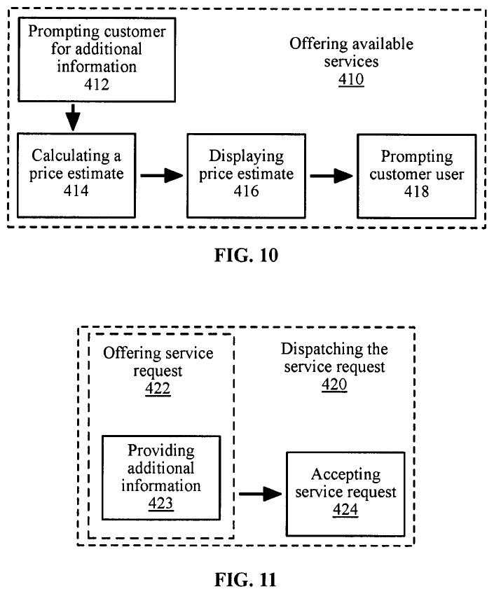

The present invention also provides a method 400 for dispatching a service. Referring now to FIG. 9, the method comprises comprising offering available services 410 to a customer user for selection by said customer user. In certain embodiments and referring to FIG. 10, the first step 410 may further comprise prompting the customer user to input additional information 412 regarding the services requested by said customer user as well as calculating a price estimate 414, displaying the price estimate for preapproval 416 and prompting the customer user to accept or reject the price estimate 418.

The method 400 further comprises dispatching the service request 420 to a pool of service providers identified as being able to offer the requested service. In certain embodiments and referring to FIG. 11, dispatching the service request 420 may comprise offering the service request 422 to a service provider meeting certain predetermined requirements such as, for example, geographic location, availability or any other suitable requirement. Offering the service request 422 may similarly comprise providing additional information 423 to the service provider including, for example, the requested time frame, the price estimate and any other relevant information. Dispatching the service request 420 may similarly comprise accepting the service request 424 if the conditions are suitable for a service provider.

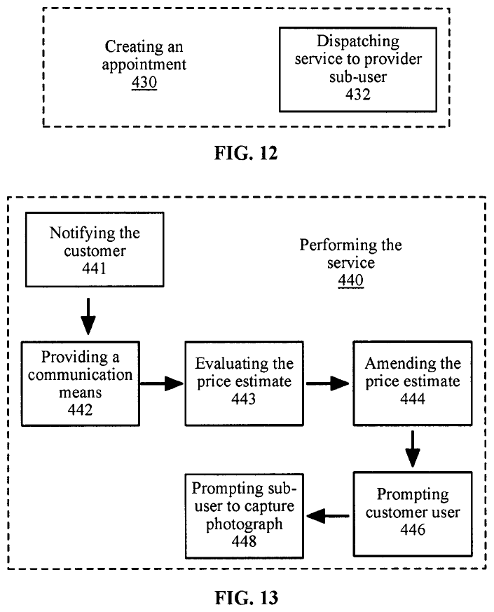

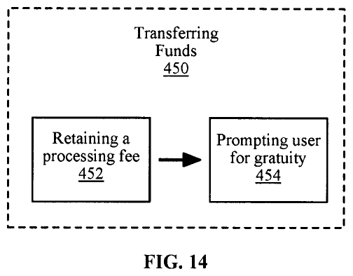

The method 400 further comprises creating an appointment 430. Referring to FIG. 12, creating of an appointment 430 may further comprise dispatching the service to a provider sub-user 432.

The method 400 comprises performing the service 440. In certain embodiments and referring to FIG. 13, performing the service 440 may comprise notifying the customer user 441 that the provider sub-user is on their way to perform the service and providing a communication means 442 between the customer user and the provider sub-user. Performing the service 440 may further comprise evaluating the price estimate 443 and, optionally, amending the price estimate 444 followed by prompting the customer user 446 to consent to the amended price estimate. Performing the service 440 may optionally comprise prompting the provider sub-user to capture a photograph 448 providing evidence of the completed service.

Finally, the method 400 comprises transferring funds 450 from the customer user to the service provider. In certain embodiments, transferring funds 450 may further comprise retaining a processing fee 452 and prompting the customer user for a gratuity 454.

While illustrative and presently preferred embodiment(s) of the invention have been described in detail hereinabove, it is to be understood that the inventive concepts may be otherwise variously embodied and employed and that the appended claims are intended to be construed to include such variations except insofar as limited by the prior art.

1. A service dispatching system comprising:
a server;
a computerized customer system adapted to communicate through a network in communication with the server, the customer system being configured to:
send a service request;
input at least one first criterion about a service; and
receive notifications;
one or more computerized provider systems in communication with the server operable to receive the service request from the server;
wherein the server is configured to dispatch the service request to one or more service provider systems matching the at least one first criterion about the service; and
the provider system is configured to dispatch the service request to a sub-user of the provider system.

2. The service dispatching system of claim 1, wherein the server is adapted to prompt the customer system to provide specifications regarding at least one second criterion about the service.

3. The service dispatching system of claim 2, wherein the server is adapted to provide the customer system instructions regarding an assessment of the at least one second criterion.

4. The service dispatching system of claim 2, wherein the server is adapted to dispatch the service request to one or more service providers matching the at least one second criterion.

5. The service dispatching system of claim 1, wherein the server is adapted to calculate a first price estimate associated to the service request.

6. The service dispatching system of claim 5, wherein the provider system is adapted to accept the price estimate or provide a second price estimate.

7. The service dispatching system of claim 6, wherein the server is adapted to prompt the customer system to accept the second price estimate.

8. The service dispatching system of claim 1, wherein the server is configured to selectively restrict communication between the customer system and the provider system.

9. The service dispatching system of claim 1 further comprising one or more administrator systems adapted to verify compliance of the customer system and the one or more provider systems.

10. The service dispatching system of claim 1, wherein the provider system comprises an image capturing module.

11. A computer-implemented method of dispatching a service comprising:
a. a server receiving a service request from a computerized customer device, the service request comprising at least one first criterion about a service;
b. the server dispatching the service request to one or more computerized service providers matching the at least one first criterion;
c. the server receiving an acceptance notification from one of the one or more service providers;
d. the server scheduling an appointment;
e. the service provider dispatching the appointment to a sub-user of the service provider.

12. The method of claim 11 further comprising the server preparing an estimated cost and prompting the customer device to accept the estimated cost.

13. The method of claim 12 further comprising the server prompting the sub-user of the service provider to evaluate the estimated cost.

14. The method of claim 11 further comprising the server prompting the customer system to provide at least one second criterion regarding the service request.

15. The method of claim 14 further comprising providing the customer system instructions regarding an assessment of the second criterion.

16. The method of claim 14, wherein the server dispatching the service request comprises dispatching the service request to the provider matching the at least one second criterion.

17. The method of claim 11 further comprising the server alerting the customer device when the sub-user is geo-located within a predetermined distance from a location associated with the service request.

18. The method of claim 11 further comprising the server enabling communication between the communication device and the sub-user of the service provider for a predetermined period prior to a time associated with the service request.

19. The method of claim 11 further comprising the server prompting the sub-user of the service provider to take a photograph after a completion of the service request.
